(19) United States
(12) Patent Application Publication
(10) Pub. No.: US 2025/0038204 A1
(43) Pub. Date: Jan. 30, 2025

(54) NEGATIVE ELECTRODE SHEET, BATTERY, AND ELECTRICITY-CONSUMPTION DEVICE

(71) Applicants: Shenzhen Hithium Energy Storage Technology Co., Ltd., Shenzhen City (CN); Xiamen Hithium Energy Storage Technology Co., Ltd., Xiamen (CN)

(72) Inventors: Fuxi PENG, Shenzhen City (CN); Qin ZHANG, Shenzhen City (CN)

(73) Assignees: Shenzhen Hithium Energy Storage Technology Co., Ltd., Shenzhen City (CN); Xiamen Hithium Energy Storage Technology Co., Ltd., Xiamen (CN)

(21) Appl. No.: 18/757,061

(22) Filed: Jun. 27, 2024

(30) Foreign Application Priority Data
Jul. 26, 2023 (CN) 202310922205.4

(51) Int. Cl. H01M 4/583; H01M 4/02

(52) U.S. Cl. CPC H01M 4/583; H01M 2004/021; H01M 2004/027

(57) ABSTRACT

A negative electrode sheet, a battery, and an electricity-consumption device are disclosed. The negative electrode sheet includes a current collector and a negative active material layer. When a state of charge of a battery is 100% or a voltage of the battery is 3.65 V, a differential scanning calorimeter curve of the negative active material layer includes: a first exothermic peak from 120° C. to 150° C., in which the negative active material layer has heat release A1 satisfying 2J/gSA1≤50 J/g; a second exothermic peak from 220° C. to 260° C., in which the negative active material layer has heat release A2 satisfying 20J/g≤A2≤100 J/g; and a third exothermic peak from 260° C. to 310° C., in which the negative active material layer has heat release A3 satisfying 200J/g≤A3≤600J/g.

### CROSS-REFERENCE TO RELATED APPLICATIONS

This application claims priority under 35 U.S.C. § 119(a) to and the benefit of Chinese Patent Application No. 202310922205.4, filed Jul. 26, 2023, the entire disclosure of which is incorporated herein by reference.

### TECHNICAL FIELD

This disclosure relates to the technical field of electrode materials, and in particular to a negative electrode sheet, a battery, and an electricity-consumption device.

### BACKGROUND

Currently, a secondary battery (such as a lithium-ion battery and a sodium-ion battery) is widely used in fields such as electric vehicles, portable mobile devices, and aerospace because the secondary battery has high energy density, a long service life, no memory effect, a low self-discharge rate, etc. However, the secondary battery still has serious safety concerns. Smoking, combustion, explosion, and other safety accidents caused by thermal runaway of the battery are the most common concerns.

### SUMMARY

In a first aspect, a negative electrode sheet is provided in the present disclosure. The negative electrode sheet includes a current collector and a negative active material layer disposed on the current collector. The negative active material layer includes a negative active material. When a state of charge (SOC) of a battery with the negative electrode sheet is 100% or a voltage of the battery is 3.65V, a differential scanning calorimeter (DSC) curve of the negative active material layer includes: a first exothermic peak from 120° C. to 150° C., in which the negative active material layer has heat release A1 satisfying 2 J/g≤A1≤50 J/g; a second exothermic peak from 220° C. to 260° C., in which the negative active material layer has heat release A2 satisfying 20 J/g≤A2≤100 J/g; and a third exothermic peak from 260° C. to 310° C., in which the negative active material layer has heat release A3 satisfying 200 J/g≤A3≤600 J/g.

In a second aspect, a battery is further provided in the present disclosure. The battery includes electrolyte, a positive electrode sheet, a separator, and the negative electrode sheet of the first aspect. The positive electrode sheet is at least partially immersed in the electrolyte. The separator is located at one side of the positive electrode sheet and is at least partially immersed in the electrolyte. The negative electrode sheet is disposed at one side of the separator away from the positive electrode sheet and at least partially immersed in the electrolyte. It can be understood that the battery has all technical effects of the negative electrode sheet of the first aspect, which is not repeated herein. The negative electrode sheet includes a current collector and a negative active material layer disposed on the current collector. The negative active material layer includes a negative active material. When a state of charge (SOC) of a battery with the negative electrode sheet is 100% or a voltage of the battery is 3.65V, a differential scanning calorimeter (DSC) curve of the negative active material layer includes: a first exothermic peak from 120° C. to 150° C., in which the negative active material layer has heat release A1 satisfying 2 J/g≤A1≤50 J/g; a second exothermic peak from 220° C. to 260° C., in which the negative active material layer has heat release A2 satisfying 20 J/g≤A2≤100 J/g; and a third exothermic peak from 260° C. to 310° C., in which the negative active material layer has heat release A3 satisfying 200 J/g≤A3≤600 J/g.

In a third aspect, an electricity-consumption device is further provided in the present disclosure. The electricity-consumption device includes a battery. The battery includes electrolyte, a positive electrode sheet, a separator, and the negative electrode sheet of the first aspect. The positive electrode sheet is at least partially immersed in the electrolyte. The separator is located at one side of the positive electrode sheet and is at least partially immersed in the electrolyte. The negative electrode sheet is disposed at one side of the separator away from the positive electrode sheet and at least partially immersed in the electrolyte. It can be understood that the battery has all technical effects of the negative electrode sheet of the first aspect, which is not repeated herein. The negative electrode sheet includes a current collector and a negative active material layer disposed on the current collector. The negative active material layer includes a negative active material. When a state of charge (SOC) of a battery with the negative electrode sheet is 100% or a voltage of the battery is 3.65V, a differential scanning calorimeter (DSC) curve of the negative active material layer includes: a first exothermic peak from 120° C. to 150° C., in which the negative active material layer has heat release A1 satisfying 2 J/g≤A1≤50 J/g; a second exothermic peak from 220° C. to 260° C., in which the negative active material layer has heat release A2 satisfying 20 J/g≤A2≤100 J/g; and a third exothermic peak from 260° C. to 310° C., in which the negative active material layer has heat release A3 satisfying 200 J/g≤A3≤600 J/g.

### BRIEF DESCRIPTION OF THE DRAWINGS

In order to describe technical solutions in embodiments of the present disclosure or the related art more clearly, the following will give a brief introduction to the accompanying drawings required for describing embodiments or the related art. Apparently, the accompanying drawings hereinafter described are merely some embodiments of the present disclosure. Based on these drawings, those of ordinary skill in the art can also obtain other drawings without creative effort.

FIG. 1 is a schematic cross-sectional view of a negative electrode sheet according to an embodiment.

FIG. 2 is a schematic view of a battery according to an embodiment.

FIG. 3 is a schematic view of an electricity-consumption device according to an embodiment.

FIG. 4 is an overcharge curve of a secondary battery of graphite according to embodiment 1.

FIG. 5 is an overcharge curve of a secondary battery of graphite according to comparative embodiment 2.

### DETAILED DESCRIPTION

The following will clearly and completely describe technical solutions for embodiments of the present disclosure with reference to accompanying drawings. Apparently, embodiments described herein are merely some of, rather than all the embodiments of the present disclosure. Based on the embodiments of the present disclosure, all other embodiments obtained by those of ordinary skill in the art without creative effort shall fall in the scope of protection of the present disclosure.

It may be noted that when a component is “fixed” to another component, the component may be fixed to the other component directly or via an intermediate component. When a component is “connected” to another component, the component may be connected to the other component directly or via an intermediate component.

Unless otherwise defined, all technical and scientific terms used herein have the same meaning as commonly understood by those of ordinary skill in the art of the present disclosure. The terms used herein in the present disclosure are for the purpose of describing embodiments only and are not intended to limit the present disclosure. The term “and/or” used herein includes any and all combinations of one or more of associated listed items.

In related researches, there have been many researches on thermal management of a positive electrode of the battery. However, currently, in terms of a carbon material negative electrode (especially, a graphite negative electrode), researches on exothermic characteristics and exothermic indexes of the battery remains unclear. Therefore, how to provide a safe negative active material that can reduce occurrence of the thermal runaway becomes a critical issue.

The present disclosure is intended to provide a negative electrode sheet 100, a battery 1000, and an electricity-consumption device 2000, so as to reduce occurrence of thermal runaway of the negative electrode sheet 100 during operation.

In order to achieve the purpose of the present disclosure, the present disclosure provides the following technical solutions.

In a first aspect, a negative electrode sheet 100 is provided in the present disclosure. The negative electrode sheet 100 includes a current collector 20 and a negative active material layer 10 disposed on the current collector 20. The negative active material layer 10 includes a negative active material 11, and the negative active material 11 has a preset particle diameter and/or a preset specific surface area. When a state of charge (SOC) of a battery with the negative electrode sheet 100 is 100% or a voltage of the battery is 3.65V, a differential scanning calorimeter (DSC) curve of the negative active material layer 10 includes: a first exothermic peak from 120° C. to 150° C., in which the negative active material layer 10 has heat release A1 satisfying 2 J/g≤A1≤50 J/g; a second exothermic peak from 220° C. to 260° C., in which the negative active material layer 10 has heat release A2 satisfying 20 J/g≤A2≤100 J/g; and a third exothermic peak from 260° C. to 310° C., in which the negative active material layer 10 has heat release A3 satisfying 200 J/g≤A3≤600 J/g. The DSC curve of the negative active material layer 10 is obtained by a DSC through measurement, and the measurement is performed by adding the negative active material layer 10 and electrolyte into a gold-plated crucible at a mass ratio of 0.78:1 and heating the gold-plated crucible from 30° C. to 450° C. at a heating rate of 5° C./min.

The heat release corresponding to the first exothermic peak is controlled within the above range, so that a content of a solid electrolyte interface (SEI) generated on the negative active material 11 can be ensured to be within an appropriate range, thereby balancing electrochemical performance of the battery. If the heat release A1 corresponding to the first exothermic peak is below the above range, it indicates that the negative active material 11 has a relatively low content and poor quality of the SEI, so that the SEI tends to be broken in the later cycles and side reaction is prone to occur between active ions in the negative active material 11 and the electrolyte, which will affect capacity and cycle life of the battery. If the heat release A1 corresponding to the first exothermic peak is above the above range, it indicates that the negative active material 11 has a relatively high content of the SEI, so that a lot of active ions are consumed in a first cycle. In this case, the capacity of the battery is reduced, and an interface of the negative active material 11 is extremely unstable, so that the thermal runaway is easily aggravated.

The heat release corresponding to the second exothermic peak is controlled within the above range, so that the negative active material 11 can be ensured to have strong thermal stability in the electrolyte, thereby balancing so that the electrochemical performance of the battery and avoiding the thermal runaway. If the heat release A2 corresponding to the second exothermic peak is below the above range, it indicates that reaction between the negative active material 11 and the electrolyte is relatively weak and dead lithium (inactive alkali metal ion) is too much, so that the battery capacity is poor. If the heat release A2 corresponding to the second exothermic peak is above the above range, it indicates that the reaction between the negative active material 11 and the electrolyte is relatively strong and overall reactivity of a lithiated negative active material 11 is relatively high, so that the thermal runaway is easily aggravated.

The heat release corresponding to the third exothermic peak is controlled within the above range, so that the negative active material 11 can be ensured to have strong thermal stability with a binder, thereby balancing the electrochemical performance of the battery and avoiding the thermal runaway. If the heat release A3 corresponding to the third exothermic peak is below t the above range, it indicates that reaction between the binder and lithiated graphite is relatively weak and dead lithium (inactive alkali metal ion) is too much, so that the battery capacity is poor. If the heat A3 corresponding to the third exothermic peak is above the above range, it indicates that the reaction between the lithiated graphite and the binder is relatively strong and the overall reactivity of the lithiated negative active material 11 is relatively high, so that the thermal runaway is easily aggravated.

The negative active material 11 satisfying the above relationship can significantly improve high-temperature stability of the negative electrode sheet 100 with the negative active material 11. In this way, an assembled battery can be ensured to maintain relatively low heat release in three different heat release stages under a high-temperature operating environment, so that relatively high heat release due to excessive temperature can be avoided in the three heat release stages, and the thermal runaway can be avoided. For the negative active material 11 satisfying the above relationship, heat release in each temperature range is controlled within a range that the battery can tolerate, so that the battery will not spontaneously combust or explode due to excessive heat, which means that the negative electrode sheet 100 has excellent high-temperature stability.

In an embodiment, peak shapes of the first exothermic peak, the second exothermic peak, and the third exothermic peak include one or any combination of a single characteristic peak shape, a double shoulder peak shape, or a continuous peak shape.

In an embodiment, the heat release A1 corresponding to the first exothermic peak and the heat release A3 corresponding to the third exothermic peak satisfy: 0.003≤A1/A3≤0.25. If A1/A3 is less than 0.003, it indicates that the quality of the SEI is poor, and reactivity of the binder and the lithiated graphite is high, so that the battery life will be affected. If A1/A3 is greater than 0.25, it indicates that the SEI is too thick and extremely unstable, and the SEI is prone to be broken to generate a large amount of heat, so that the thermal runaway is more likely to occur.

In an embodiment, the heat release A2 corresponding to the second exothermic peak and the heat release A3 corresponding to the third exothermic peak satisfy: 0.03≤A2/A3≤0.5. If A2/A3 is less than 0.03, it indicates that dead lithium in the lithiated graphite is too much, and the reactivity of the binder and the lithiated graphite is high, so that the battery life will be affected. If A2/A3 is greater than 0.5, it indicates that reaction between the lithiated graphite and the electrolyte is strong and a large amount of heat is generated, so that the thermal runaway of the battery is triggered.

In an embodiment, a particle diameter Dv50 of the negative active material 11 satisfies 10 μm≤Dv50≤17 μm, where the Dv50 refers to a particle diameter when a cumulative volume fraction reaches 50% in measuring a volume-based distribution using a laser scattering method. By further limiting a particle diameter of the negative active material 11, heat generated by reaction between the negative active material 11 and the electrolyte 400 can be further reduced by controlling the particle diameter while controlling the heat release, so that the negative active material 11 can be ensured to have relatively high thermal stability. If the particle diameter of the negative active material 11 is below the above range, it indicates that the negative active material 11 in the negative active material layer 10 has a relatively small particle diameter, which not only easily causes a lot of side reactions but also increases preparation difficulty of the negative active material 11. In this case, the negative active material 11 is easily agglomerated and difficultly subdivided. When the particle diameter of the negative active material 11 is above the above range, the particle is too large, so that storage sites of alkali metal ions decrease and capacity of the battery is relatively poor.

In an embodiment, the specific surface area of the negative active material 11 satisfies 1.1 m²/g to 4.5 m²/g. Since the specific surface area will affect initial coulombic efficiency (ICE) of the negative active material 11 and deintercalation of the active ions (lithium-ions or sodium-ions), a larger specific surface area causes lower ICE, a smaller specific surface area is not conducive to the deintercalation of the active ions, and the specific surface area of the negative active material 11 maintained within the above range can ensure that the negative active material 11 can have excellent electrochemical performance.

In an embodiment, a gram capacity of the negative active material 11 ranges from 330 mAh/g to 360 mAh/g.

In an embodiment, the negative active material 11 is one or more of a graphite particle, a soft carbon particle, or a hard carbon particle. The graphite particle may be natural graphite or artificial graphite, which is not limited in the present disclosure. A shape of the graphite particle is not limited and may be spherical, plate-shaped, etc. A graphite material is the most widely used negative active material 11. The graphite material has good conductivity, which can not only improve conductivity of a silicon material but also increase capacity.

In a second aspect, a battery 1000 is further provided in the present disclosure. The battery 1000 includes electrolyte 400, a positive electrode sheet 200, a separator 300, and the negative electrode sheet 100 of the first aspect. The positive electrode sheet 200 is at least partially immersed in the electrolyte 400. The separator 300 is located at one side of the positive electrode sheet 200 and is at least partially immersed in the electrolyte 400. The negative electrode sheet 100 is disposed at one side of the separator 300 away from the positive electrode sheet 200 and at least partially immersed in the electrolyte 400. It can be understood that the battery 1000 has all technical effects of the negative electrode sheet 100 of the first aspect, which is not repeated herein.

In a third aspect, an electricity-consumption device 2000 is further provided in the present disclosure. The electricity-consumption device includes the battery 1000 of the second aspect.

Some embodiments of the present disclosure will be described in detail below with reference to the accompanying drawings. The following embodiments and characteristics in the embodiments may be combined with each other without conflict.

A negative electrode sheet 100 is provided in the present disclosure. As illustrated in FIG. 1, the negative electrode sheet 100 includes a current collector 20 and a negative active material layer 10 disposed on the current collector 20. The negative active material layer 10 includes a negative active material 11. The negative active material layer 10 has a preset exothermic characteristic under preset conditions. The negative active material layer 10 with the preset exothermic characteristic can greatly improve high-temperature stability of the negative electrode sheet 100.

Specifically, when a state of charge (SOC) of a battery with the negative electrode sheet 100 is 100% or a voltage of the battery is 3.65V, a differential scanning calorimeter (DSC) curve of the negative active material layer includes a first exothermic peak, a second exothermic peak, and a third exothermic peak. The DSC curve of the negative active material layer in an immersed electrolyte is a heat release curve of the negative active material layer obtained by a DSC through measurement.

In an embodiment, the preset conditions include but are not limited to a particle diameter and/or a specific surface area of the negative active material.

In an embodiment, the negative active material layer further includes a binder and a conductive agent. The negative active material, the conductive agent, and the binder are added to a solvent and mixed to prepare a negative electrode slurry, and then the negative electrode slurry is coated on the negative electrode current collector 20 to prepare the negative electrode sheet 100.

In an embodiment, the negative electrode current collector may be one or more of a copper foil, a porous copper foil, a foamed nickel/copper foil, a galvanized copper foil, a nickel-plated copper foil, a coated-carbon copper foil, a nickel foil, a titanium foil, and a carbonaceous porous copper foil. In an embodiment, the negative electrode current collector may be one or more of the copper foil, the galvanized copper foil, the nickel-plated copper foil, and the carbon-coated copper foil.

In an embodiment, the binder may be acrylonitrile, vinylidene fluoride, vinyl alcohol, carboxymethyl cellulose, lithium carboxymethyl cellulose, sodium carboxymethyl cellulose, methacryloyl, acrylic acid, lithium acrylate, acrylamide, amide, imide, acrylate, styrene-butadiene rubber, sodium alginate, chitosan, ethanediol, guar gum monomer, polymer, or copolymer.

In an embodiment, the conductive agent may be at least one of conductive carbon black, acetylene black, graphite, graphene, carbon micro-nano linear conductive material, or carbon micro-nano tubular conductive material.

A specific DSC method for testing the negative active material layer is as follows. A fully-charged battery is disassembled in a glove box, to obtain a negative electrode sheet. The negative electrode sheet is cut into 2 cm*2 cm sample electrode sheets to be tested, and the sample electrode sheets to be tested are rinsed with dimethyl carbonate (DMC) for 3 minutes and dried at room temperature in the glove box for 8 hours, to obtain a negative active material on the dried sample electrode sheets to be tested. 3 mg of the negative active material is put into a crucible of a DSC, 2 mg of electrolyte is added to the crucible, and then the crucible is sealed and waited for testing. A condition for the DSC test is set to increase the temperature from 30° C. to 450° C. at a heating rate of 5° C./min. The test is completed and a test result is obtained.

In an embodiment, the crucible is gold-plated.

In an embodiment, the electrolyte is formed by mixing ethylene carbonate (EC) and ethyl methyl carbonate (EMC) at a volume ratio of 3:7 and adding lithium hexafluorophosphate (LiPF₆) to the mixture, where the LiPF₆ has a concentration of 1 mol/L.

The DSC can measure a heat-flow-power difference between a sample and a reference with changes in temperature or time under control of a certain temperature program (ascending/descending/constant temperature) and under a certain atmosphere. Based on this, information related to thermal effects such as heat absorption, heat release, and specific heat changes of the sample under the control of the temperature program can be obtained, and the heat absorption/release (enthalpy) and characteristic temperature (a starting point, a peak value, and an ending point) of the thermal effects can be calculated.

Further, the first exothermic peak appears from 120° C. to 150° C., the second exothermic peak appears from 220° C. to 260° C., and the third exothermic peak appears from 260° C. to 310° C. For example, an apex of the first exothermic peak may be in the temperature range from 120° C. to 150° C., and an apex of an exothermic peak refers to a maximum point of the exothermic peak in a corresponding temperature range.

The first exothermic peak actually corresponds to an exothermic peak of reaction of an outer SEI. It can be understood that the SEI is formed during a first charging and discharging process of the battery, and the SEI is a passivation film formed on the surface of the negative active material by active ions (lithium-ions or sodium-ions) and the solvent (EC/DMC). Therefore, the first exothermic peak is actually heat release before the SEI is broken. In the present disclosure, heat release corresponding to the SEI can be obtained by integrating the exothermic peak within the range from 120° C. to 150° C. in a DSC test spectrum, where a unit of the heat release is Joule (J).

The second exothermic peak corresponds to an exothermic peak of reaction between the negative active material and the electrolyte. It can be understood that in the present disclosure, a negative active material in a fully-charged state is provided for the DSC test, and the negative active material is in direct contact with the electrolyte after the SEI is broken, so that the reaction between the negative active material and the electrolyte is intensified, and a large amount of heat is released.

The third exothermic peak corresponds to an exothermic peak of reaction between the negative active material and the binder. It can be understood that after the reaction between the negative active material and the electrolyte is completed, the electrolyte is consumed, so that the negative active material further reacts with the binder attached to the surface of the negative active material, thereby releasing heat.

In an embodiment, the first exothermic peak appears from 120° C. to 150° C., in which the negative active material layer has heat release A1 satisfying 2 J/g≤A1≤50 J/g. In an embodiment, the heat release A1 may be, but is not limited to, 2 J/g, 10 J/g, 15 J/g, 20 J/g, 25 J/g, 30 J/g, 35 J/g, 40 J/g, 45 J/g, or 50 J/g.

It can be seen from the embodiment above that the heat release A1 corresponding to the first exothermic peak actually reflects the heat release generated before the SEI is broken. At the same time, the heat release generated before the SEI is broken is proportional to a content of the SEI. In other words, a thicker SEI causes a higher exothermic peak in the DSC curve, or a higher heat release obtained represents a higher content of the SEI in a negative active material to be tested.

Therefore, the heat release corresponding to the first exothermic peak is controlled within the above range, so that the content of the SEI generated on the negative active material can be ensured to be within an appropriate range, thereby balancing electrochemical performance of the battery. If the heat release A1 corresponding to the first exothermic peak is below the above range, it indicates that the negative active material has a relatively low content of the SEI, so that side reaction is prone to occur between the active ions in the negative active material and the electrolyte and dead lithium (inactive alkali metal ion) in the negative active material is too much, which will affect capacity and cycle life of the battery. If the heat release A1 corresponding to the first exothermic peak is above the above range, it indicates that the negative active material has a relatively high content of the SEI, so that a large amount of active ions is consumed in a first cycle. In this case, the capacity of the battery is reduced, and an interface of the negative active material is extremely unstable, so that thermal runaway is easily aggravated.

In an embodiment, the second exothermic peak appears from 220° C. to 260° C., in which the negative active material layer has heat release A2 satisfying 20 J/g≤A2≤100 J/g. In an embodiment, the heat release A2 may be, but is not limited to, 20 J/g, 30 J/g, 40 J/g, 50 J/g, 60 J/g, 70 J/g, 80 J/g, 90 J/g, or 100 J/g.

It can be seen from the embodiment above that the heat release A2 corresponding to the second exothermic peak actually reflects the heat release generated during the reaction between the negative active material and the electrolyte. The heat release A2 can reflect intensity of the reaction between the negative active material and the electrolyte. In other words, stronger reaction between the negative active material and the electrolyte causes a higher exothermic peak in the DSC curve, or higher heat release obtained represents poorer thermal stability of the negative active material.

Therefore, the heat release corresponding to the second exothermic peak is controlled within the above range, so that the negative active material can be ensured to have strong thermal stability in the electrolyte, thereby balancing the electrochemical performance of the battery and avoiding the thermal runaway. If the heat release A2 corresponding to the second exothermic peak is below the above range, it indicates that the reaction between the negative active material and the electrolyte is relatively weak and dead lithium (inactive alkali metal ion) is too much, so that the battery capacity is poor. If the heat release A2 corresponding to the second exothermic peak is above the above range, it indicates that the reaction between the negative active material and the electrolyte is relatively strong and overall reactivity of a lithiated negative active material is relatively high, so that the thermal runaway is easily aggravated.

In an embodiment, the third exothermic peak appears from 260° C. to 310° C., in which the negative active material layer has heat release A3 satisfying 200 J/g≤A3≤600 J/g. In an embodiment, the heat release A3 may be, but is not limited to, 200 J/g, 250 J/g, 300 J/g, 350 J/g, 400 J/g, 450 J/g, 500 J/g, 550 J/g, or 600 J/g.

It can be seen from the embodiment above that the heat release A3 corresponding to the third exothermic peak actually reflects the heat release generated during the reaction between the negative active material and the binder. The heat release A3 can reflect intensity of the reaction between the negative active material and the binder. In other words, stronger reaction between the negative active material and the binder causes a higher exothermic peak in the DSC curve, or higher heat release obtained represents poorer thermal stability of the negative active material.

Therefore, the heat release corresponding to the third exothermic peak is controlled within the above range, so that the negative active material can be ensured to have strong thermal stability with the binder, thereby balancing the electrochemical performance of the battery and avoiding the thermal runaway. If the heat release A3 corresponding to the third exothermic peak is below the above range, it indicates that the reaction between the negative active material and the binder is relatively weak and dead lithium (inactive alkali metal ion) is too much, so that the battery capacity is poor. If the heat release A3 corresponding to the third exothermic peak is above the above range, it indicates that the reaction between the negative active material and the binder is relatively strong and the overall reactivity of the lithiated negative active material is relatively high, so that the thermal runaway is easily aggravated.

The negative active material satisfying the above relationship can significantly improve high-temperature stability of the negative electrode sheet with the negative active material. In this way, an assembled battery can be ensured to maintain relatively low heat release in three different heat release stages under a high-temperature operating environment, so that relatively high heat release due to excessive temperature can be avoided in the three heat release stages, and the thermal runaway can be avoided. For the negative active material satisfying the above relationship, heat release in each temperature range is controlled within a range that the battery can tolerate, so that the battery will not spontaneously combust or explode due to excessive heat, which means that the negative electrode sheet has excellent high-temperature stability.

In an embodiment, peak shapes of the first exothermic peak, the second exothermic peak, and the third exothermic peak include one or any combination of a single characteristic peak shape, a double shoulder peak shape, or a continuous peak shape.

In an embodiment, the heat release A1 corresponding to the first exothermic peak and the heat release A3 corresponding to the third exothermic peak satisfy: 0.003≤A1/A3≤0.25. In an embodiment, A1/A3 may be, but are not limited to, 0.003, 0.01, 0.02, 0.05, 0.07, 0.1, 0.12, 0.14, 0.18, 0.2, 0.23, or 0.25.

If A1/A3 is less than 0.003, it indicates that the active ions are not active enough and the battery life will be affected. If A1/A3 is greater than 0.25, it indicates that the SEI is too thick and extremely unstable, and the SEI is prone to be broken to generate a large amount of heat, so that the thermal runaway is more likely to occur.

In an embodiment, the heat release A2 corresponding to the second exothermic peak and the heat release A3 corresponding to the third exothermic peak satisfy: 0.03≤A2/A3≤0.25. In an embodiment, A2/A3 may be, but is not limited to, 0.03, 0.04, 0.05, 0.06, 0.08, 0.1, 0.15, 0.2, 0.25, 0.3, 0.35, 0.4, or 0.5.

If A2/A3 is less than 0.03, it indicates that the active ions are not active enough and the battery life will be affected. If A2/A3 is greater than 0.5, it indicates that the reaction between the negative active material and the electrolyte is strong and a large amount of heat is generated, so that the thermal runaway is triggered.

In an embodiment, a particle diameter Dv50 of the negative active material satisfies 10 μm≤Dv50≤17 μm, where the Dv50 refers to a particle diameter when a cumulative volume fraction reaches 50% in measuring a volume-based distribution using a laser scattering method.

The Dv50 may be measured as follows. According to a GB/T19077-2016 standard, a graphite particle is sampled and measured by a laser-diffraction particle size distribution analyzer (Malvern Mastersizer 3000).

In an embodiment, the particle diameter Dv50 of the negative active material may be, but is not limited to, 10 μm, 11 μm, 12 μm, 13 μm, 14 μm, 15 μm, 16 μm, or 17 μm.

Further, in addition to controlling the heat release corresponding to the negative active material, the particle diameter of the negative active material further needs to be controlled, so that the negative active material is not too large or too small. Since an excessively small negative active material has a relatively large specific surface area, the reactivity between the electrolyte and the negative active material increases, so that side reaction between the negative active material layer and the electrolyte is aggravated and heat accumulation is caused, thereby leading to thermal runaway.

By further limiting a particle diameter of the negative active material, heat generated by reaction between the negative active material and the electrolyte can be further reduced by controlling the particle diameter while controlling the heat release, so that the negative active material can be ensured to have relatively high thermal stability.

If the particle diameter of the negative active material is below the above range, it indicates that the negative active material in the negative active material layer has a relatively small particle diameter, which not only easily causes a lot of side reactions but also increases preparation difficulty of the negative active material. In this case, the negative active material is easily agglomerated and difficultly subdivided. When the particle diameter of the negative active material is above the above range, the particle is too large, so that storage sites of alkali metal ions decrease and capacity of the battery is relatively poor.

In an embodiment, the specific surface area of the negative active material satisfies 1.1 m²/g to 4.5 m²/g. Specifically, the specific surface area of the negative active material may be, but is not limited to, 1.1 m²/g, 1.15 m²/g, 1.2 m²/g, 1.25 m²/g, 1.3 m²/g, 1.35 m²/g, 1.4 m²/g, or 4.5 m²/g.

Since the specific surface area will affect initial coulombic efficiency (ICE) of the negative active material and deintercalation of the active ions, a larger specific surface area causes lower ICE, smaller specific surface area is not conducive to the deintercalation of the active ions, and the specific surface area of the negative active material maintained within the above range can ensure that the negative active material can have excellent electrochemical performance.

In an embodiment, a gram capacity of the negative active material ranges from 330 mAh/g to 360 mAh/g. Specifically, the gram capacity of the negative active material may be, but is not limited to, 330 mAh/g, 340 mAh/g, 341 mAh/g, 342 mAh/g, 343 mAh/g, 344 mAh/g, 345 mAh/g, 346 mAh/g, 347 mAh/g, 348 mAh/g, 349 mAh/g, 350 mAh/g, or 360 mAh/g.

In an embodiment, the negative active material is one or more of a graphite particle, a soft carbon particle, or a hard carbon particle.

The graphite particle may be natural graphite or artificial graphite, which is not limited in the present disclosure. A shape of the graphite particle is not limited and may be spherical, plate-shaped, etc. A graphite material is the most widely used negative active material. The graphite material has good conductivity, which can not only improve conductivity of a silicon material but also increase capacity.

In an embodiment, the negative active material may be one or more of negative active materials that are subject to: surface treatments such as spheroidization or structural modification, oxidation, etching, etc.; or doping with nitrogen, phosphorus, sulfur, iron, cobalt, nickel, aluminum, zinc, or the like; or modification treatments such as being coated with an amorphous carbon layer, etc.

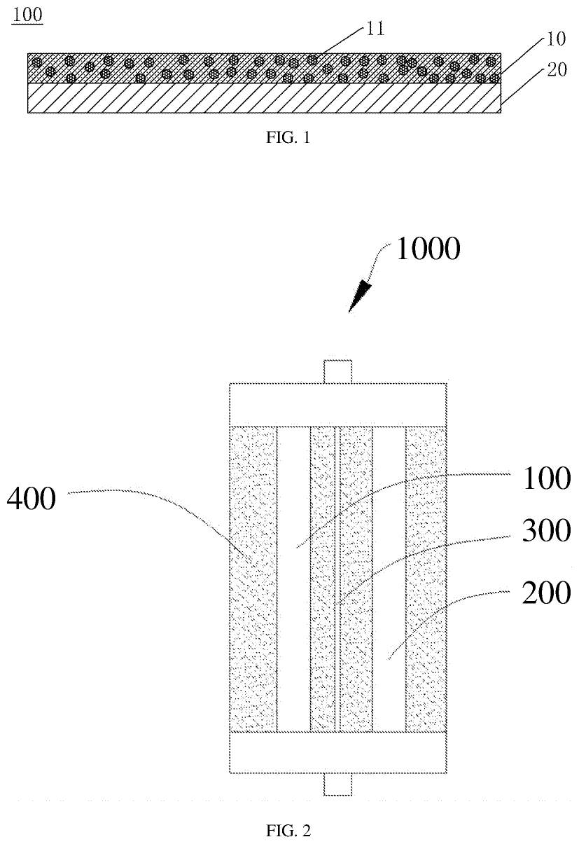

In an embodiment, a battery 1000 is further provided in the present disclosure. As illustrated in FIG. 2, the battery includes 1000 electrolyte 400, a positive electrode sheet 200, a separator 300, and the negative electrode sheet 100 of the first aspect. The positive electrode sheet 200 is at least partially immersed in the electrolyte 400. The separator 300 is located at one side of the positive electrode sheet 200 and is at least partially immersed in the electrolyte 400. The negative electrode sheet 100 is disposed at one side of the separator 300 away from the positive electrode sheet 200 and at least partially immersed in the electrolyte 400. Since the battery 1000 provided in the present disclosure adopts the negative electrode sheet 100 provided in the present disclosure, the battery 1000 has good high-temperature stability and safety, thereby facilitating application of the battery in various fields.

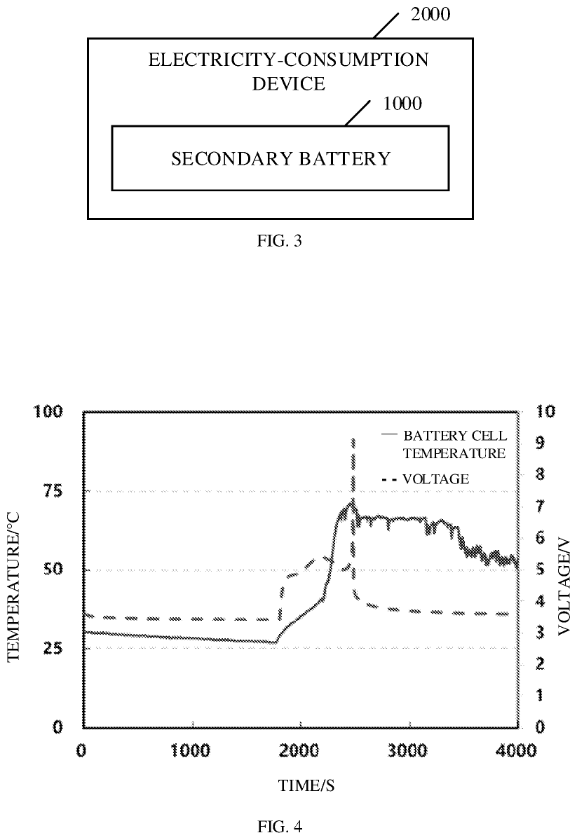

In an embodiment, as illustrated in FIG. 3, an electricity-consumption device 2000 is further provided in the present disclosure. The electricity-consumption device 2000 includes the battery 1000 described above. The electricity-consumption device 2000 adopting the battery 1000 can have high-temperature stability.

Technical solutions of the present disclosure will be further described below with reference to embodiments and accompanying drawings.

### Embodiment 1

Preparation of a graphite particle is as follows. A coke raw material is crushed, graphitized, screened and demagnetized, etc., and then artificial graphite is obtained. The artificial graphite has a particle diameter distribution of Dv50=16.5 μm, a specific surface area of 1.21 m²/g, and heat release A1 of 2.2 J/g, A1/A3=0.005, and A2/A3=0.05. A negative active material layer is prepared with the graphite particle.

### Embodiment 2

Preparation of a graphite particle is as follows. A coke raw material is crushed, graphitized, screened and demagnetized, etc., and then artificial graphite is obtained. The artificial graphite has a particle diameter distribution of Dv50=15.8 μm, a specific surface area of 1.34 m²/g, and heat release A1 of 2.8 J/g, A1/A3=0.006, and A2/A3=0.06. A negative active material layer is prepared with the graphite particle.

### Embodiment 3

Preparation of a graphite particle is as follows. A coke raw material is crushed, graphitized, screened and demagnetized, etc., and then artificial graphite is obtained. The artificial graphite has a particle diameter distribution of Dv50=14.9 μm, a specific surface area of 1.38 m²/g, and heat release A1 of 3.2 J/g, A1/A3=0.006, and A2/A3=0.09. A negative active material layer is prepared with the graphite particle.

### Embodiment 4

Preparation of a graphite particle is as follows. A coke raw material is crushed, graphitized, screened and demagnetized, etc., and then artificial graphite is obtained. The artificial graphite has a particle diameter distribution of Dv50=13.2 μm, a specific surface area of 1.54 m²/g, and heat release A1 of 4.1 J/g, A1/A3=0.008, and A2/A3=0.15. A negative active material layer is prepared with the graphite particle.

### Embodiment 5

Preparation of a graphite particle is as follows. A coke raw material is crushed, graphitized, screened and demagnetized, etc., and then artificial graphite is obtained. The artificial graphite has a particle diameter distribution of Dv50=12.5 μm, a specific surface area of 1.63 m²/g, and heat release A1 of 4.5 J/g, A1/A3=0.009, and A2/A3=0.19. A negative active material layer is prepared with the graphite particle.

### Comparative Embodiment 1

Preparation of a graphite particle is as follows. A coke raw material is crushed, graphitized, screened and demagnetized, etc., and then artificial graphite is obtained. The artificial graphite has a particle diameter distribution of Dv50=11.2 μm, a specific surface area of 1.65 m²/g, and heat release A1 of 5.2 J/g, A1/A3=0.0029, and A2/A3=0.52. A negative active material layer is prepared with the graphite particle.

### Comparative Embodiment 2

Preparation of a graphite particle is as follows. A coke raw material is crushed, graphitized, screened and demagnetized, etc., and then artificial graphite is obtained. The artificial graphite has a particle diameter distribution of Dv50=10.2 μm, a specific surface area of 1.97 m²/g, and heat release A1 of 6.31 J/g, A1/A3=0.0025, and A2/A3=0.54. A negative active material layer is prepared with the graphite particle.

### Comparative Embodiment 3

Preparation of a graphite particle is as follows. A coke raw material is crushed, graphitized, screened and demagnetized, etc., and then artificial graphite is obtained. The artificial graphite has a particle diameter distribution of Dv50=17.2 μm, a specific surface area of 1.24 m²/g, and heat release A1 of 1.31 J/g, A1/A3=0.002, and A2/A3=0.025. A negative active material layer is prepared with the graphite particle.

The negative active material provided in each of embodiments 1 to 5 and the negative active material provided in one of the comparative embodiments 1 to 3 may be assembled into a negative electrode sheet and a lithium-ion secondary battery in the following methods.

Positive electrode: a positive electrode material is mixed and ball-milled with polyvinylidene fluoride and Super-P (i.e., conductive carbon black) at a mass ratio of 93:3:4 to obtain a positive electrode slurry. The positive electrode slurry is coated on a surface of an aluminum foil, is vacuum dried at 110° C. overnight, and is rolled to obtain a positive electrode sheet.

Negative electrode: a negative active material is configured with conductive carbon black, carboxymethyl cellulose (CMC), and styrene-butadiene rubber (SBR) at a mass ratio of 95%:2%:1.2%:1.8% to obtain a negative electrode slurry. The negative electrode slurry is evenly coated on an aluminum foil to obtain a negative electrode sheet.

Electrolyte: EC is mixed with EMC at a volume ratio of 3:7, and LiPF₆ is added thereto, so as to form the electrolyte. LiPF₆ has a concentration of 1 mol/L.

Separator: a polypropylene microporous separator.

Assembling of a lithium-ion secondary battery: a lithium-ion full battery is assembled in an inert-atmosphere glove box in an order of the negative electrode sheet-the separator-the electrolyte-the positive electrode sheet.

Conditions for cycle tests: the above battery obtained is subject to charging and discharging cycle tests on a charging and discharging instrument. Test temperature is 25° C., cycle rate is 1 C (i.e., both a charging rate and a discharging rate are 1 C), a charging voltage ranges from 2.5V to 3.65V, and capacity retention rate after cycles is calculated. A formula for calculating the capacity retention rate of the cycles is: capacity retention rate after nth cycles=(discharging capacity after the nth cycles/maximum discharging capacity of the cycles)*100%.

It can be understood that a term “cycle” in the present disclosure refers to the number of times the battery is charged at preset rate and discharged at the preset rate. One cycle refers to completion of one charging and discharging process by the battery. Capacity retention rate after 500 cycles refers to the capacity retention rate of the battery after 500 cycles of the charging and discharging process at a test temperature of 25° C., a charging rate of 1 C, and a discharging rate of 1° C.

The electrochemical performance of each lithium-ion secondary battery assembled in the above lithium-ion secondary battery embodiments is tested in terms of performances as shown in Table 1, and test results are as shown in Table 1 below.

TABLE 1

| | Dv50 | Specific | | | | Retention | |
|---|---|---|---|---|---|---|---|
| | particle | surface | Gram | | | rate after | Whether |
| | diameter | area | capacity | | | 500 cycles | overcharge |
| | (μm) | (m²/g) | (mAh/g) | A1/A3 | A1/A2 | (%) | is passed |
| Embodiment 1 | 16.5 | 1.21 | 348 | 0.005 | 0.05 | 95.2 | YES |
| Embodiment 2 | 15.8 | 1.34 | 346 | 0.006 | 0.06 | 94.3 | YES |
| Embodiment 3 | 14.9 | 1.38 | 345 | 0.006 | 0.09 | 92.7 | YES |
| Embodiment 4 | 13.2 | 1.54 | 344 | 0.008 | 0.15 | 91.8 | YES |
| Embodiment 5 | 12.5 | 1.63 | 344 | 0.009 | 0.19 | 91.2 | YES |
| Comparative | 11.2 | 1.65 | 343 | 0.0029 | 0.52 | 90.2 | NO |
| embodiment 1 | | | | | | | |
| Comparative | 10.2 | 1.97 | 342 | 0.0025 | 0.54 | 86.3 | NO |
| embodiment 2 | | | | | | | |
| Comparative | 17.2 | 1.24 | 343 | 0.002 | 0.025 | 85.2 | NO |
| embodiment 3 | | | | | | | |

As can be seen from the embodiments 1 to 5, a battery assembled with the negative active material with the heat release provided in the present disclosure still can have relatively high cycle retention rate after multiple cycles. When the negative active material is used in a long-term high-temperature environment, the heat release corresponding to the negative active material in the three heat release stages is within the ranges provided in the present disclosure, and the heat release has a relatively small impact on the overall electrical performance of the battery. Therefore, the retention rate after 500 cycles of the battery can reach more than 90%.

As can be seen from the comparative embodiments 1 to 3, when any heat release of the carbon material in the three heat release stages does not satisfy the range provided in the present disclosure (any range of A1, A2, and A3), the ratio of A1/A3 or A2/A3 will become unbalanced. Therefore, the retention rate after 500 cycles of the battery is less than that of the embodiments 1 to 5. Moreover, while the heat release of the material tested in the comparative embodiment 3 is low, the material will lead to severe lithium precipitation during an overcharge process due to poor dynamics performance of the material, thereby triggering the thermal runaway.

Further, FIG. 4 illustrates an overcharge curve of a secondary battery of graphite embodiment 1. In a case where an overcharge voltage reaches 5.475V, the battery stops being charged and keeps still. In this case, a voltage of the battery cell can still maintain an initial voltage, and temperature of the battery cell is relatively low (about 53° C.), which indicates that the secondary battery provided in the embodiment 1 passes an overcharge test.

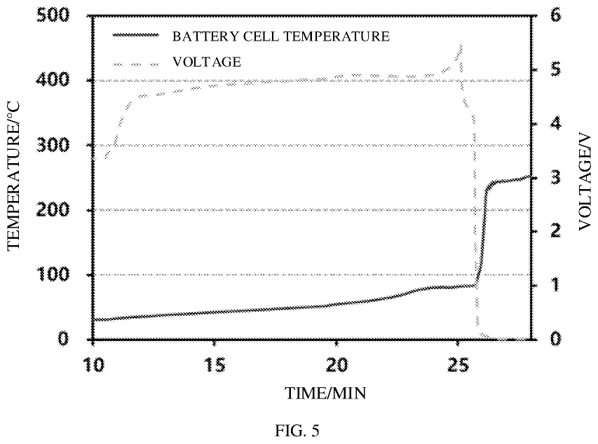

FIG. 5 illustrates an overcharge curve of a secondary battery of graphite comparative embodiment 2. In a case where an overcharge voltage reaches 5.475V, the battery stops being charged and keeps still. In this case, a voltage of the battery cell drops to 0 V, temperature of the battery cell increases to 253° C., so that the thermal runaway is triggered, which indicates that the secondary battery provided in the comparative embodiment 2 fails an overcharge test.

In description of the present disclosure, it may be understood that locations or positional relationships indicated by terms such as “center”, “on”, “under”, “left”, “right”, “vertical”, “horizontal”, “in”, “out”, and the like are locations or positional relationship based on accompanying drawings and are only for the convenience of description and simplicity, rather than explicitly or implicitly indicate that apparatuses or components referred to herein must have a certain direction or be configured or operated in a certain direction and therefore cannot be understood as limitations to the present disclosure.

The above embodiments are only preferable embodiments of the present disclosure, of course, the above embodiments cannot be used to limit the scope of this disclosure, the ordinary skill in the field can understand all or a part of the process to realize the above embodiments of the present disclosure, and the equivalent changes made in accordance with the claims of this disclosure, still belong to the scope of the present disclosure covered.

What is claimed is:

1. A negative electrode sheet, comprising a current collector and a negative active material layer disposed on the current collector, wherein the negative active material layer comprises a negative active material, and when a state of charge (SOC) of a battery with the negative electrode sheet is 100% or a voltage of the battery is 3.65V, a differential scanning calorimeter (DSC) curve of the negative active material layer comprises:
a first exothermic peak from 120° C. to 150° C., in which the negative active material layer has heat release A1 satisfying 2 J/g≤A1≤50 J/g;
a second exothermic peak from 220° C. to 260° C., in which the negative active material layer has heat release A2 satisfying 20 J/g≤A2≤100 J/g; and
a third exothermic peak from 260° C. to 310° C., in which the negative active material layer has heat release A3 satisfying 200 J/g≤A3≤600 J/g.

2. The negative electrode sheet of claim 1, wherein the DSC curve of the negative active material layer is obtained by a DSC through measurement, and the measurement is performed by adding the negative active material layer and electrolyte into a gold-plated crucible at a mass ratio of 0.78:1 and heating the gold-plated crucible from 30° C. to 450° C. at a heating rate of 5° C./min.

3. The negative electrode sheet of claim 1, wherein peak shapes of the first exothermic peak, the second exothermic peak, and the third exothermic peak comprise one or any combination of a single characteristic peak shape, a double shoulder peak shape, or a continuous peak shape.

4. The negative electrode sheet of claim 1, wherein the heat release A1 corresponding to the first exothermic peak and the heat release A3 corresponding to the third exothermic peak satisfy: 0.003≤A1/A3≤0.25.

5. The negative electrode sheet of claim 1, wherein the heat release A2 corresponding to the second exothermic peak and the heat release A3 corresponding to the third exothermic peak satisfy: 0.03≤A2/A3≤0.5.

6. The negative electrode sheet of claim 1, wherein a particle diameter Dv50 of the negative active material satisfies 10 μm≤Dv50≤17 μm, wherein the Dv50 refers to a particle diameter when a cumulative volume fraction reaches 50% in measuring a volume-based distribution using a laser scattering method.

7. The negative electrode sheet of claim 1, wherein the specific surface area of the negative active material satisfies 1.1 m²/g to 4.5 m²/g.

8. The negative electrode sheet of claim 1, wherein a gram capacity of the negative active material ranges from 330 mAh/g to 360 mAh/g.

9. The negative electrode sheet of claim 1, wherein the negative active material is one or more of a graphite particle, a soft carbon particle, or a hard carbon particle.

10. A battery, comprising:
electrolyte;
a positive electrode sheet at least partially immersed in the electrolyte;
a separator located at one side of the positive electrode sheet and at least partially immersed in the electrolyte; and
a negative electrode sheet, wherein the negative electrode sheet is disposed at one side of the separator away from the positive electrode sheet and at least partially immersed in the electrolyte;
wherein the negative electrode sheet, comprising a current collector and a negative active material layer disposed on the current collector, wherein the negative active material layer comprises a negative active material, and when a state of charge (SOC) of a battery with the negative electrode sheet is 100% or a voltage of the battery is 3.65V, a differential scanning calorimeter (DSC) curve of the negative active material layer comprises:
a first exothermic peak from 120° C. to 150° C., in which the negative active material layer has heat release A1 satisfying 2 J/g≤A1≤50 J/g;
a second exothermic peak from 220° C. to 260° C., in which the negative active material layer has heat release A2 satisfying 20 J/g≤A2≤100 J/g; and
a third exothermic peak from 260° C. to 310° C., in which the negative active material layer has heat release A3 satisfying 200 J/g≤A3≤600 J/g.

11. The battery of claim 10, wherein the DSC curve of the negative active material layer is obtained by a DSC through measurement, and the measurement is performed by adding the negative active material layer and electrolyte into a gold-plated crucible at a mass ratio of 0.78:1 and heating the gold-plated crucible from 30° C. to 450° C. at a heating rate of 5° C./min.

12. The battery of claim 10, wherein peak shapes of the first exothermic peak, the second exothermic peak, and the third exothermic peak comprise one or any combination of a single characteristic peak shape, a double shoulder peak shape, or a continuous peak shape.

13. The battery of claim 10, wherein the heat release A1 corresponding to the first exothermic peak and the heat release A3 corresponding to the third exothermic peak satisfy: 0.003≤A1/A3≤0.25.

14. The battery of claim 10, wherein the heat release A2 corresponding to the second exothermic peak and the heat release A3 corresponding to the third exothermic peak satisfy: 0.03≤A2/A3≤0.5.

15. The battery of claim 10, wherein a particle diameter Dv50 of the negative active material satisfies 10 μm≤Dv50≤17 μm, wherein the Dv50 refers to a particle diameter when a cumulative volume fraction reaches 50% in measuring a volume-based distribution using a laser scattering method.

16. The battery of claim 10, wherein the specific surface area of the negative active material satisfies 1.1 m²/g to 4.5 m²/g.

17. The battery of claim 10, wherein a gram capacity of the negative active material ranges from 330 mAh/g to 360 mAh/g.

18. The battery of claim 10, wherein the negative active material is one or more of a graphite particle, a soft carbon particle, or a hard carbon particle.

19. An electricity-consumption device, comprising a battery, wherein the battery comprises:
electrolyte;
a positive electrode sheet at least partially immersed in the electrolyte;
a separator located at one side of the positive electrode sheet and at least partially immersed in the electrolyte; and
a negative electrode sheet, wherein the negative electrode sheet is disposed at one side of the separator away from the positive electrode sheet and at least partially immersed in the electrolyte;
wherein the negative electrode sheet, comprising a current collector and a negative active material layer disposed on the current collector, wherein the negative active material layer comprises a negative active material, and when a state of charge (SOC) of a battery with the negative electrode sheet is 100% or a voltage of the battery is 3.65V, a differential scanning calorimeter (DSC) curve of the negative active material layer comprises:
a first exothermic peak from 120° C. to 150° C., in which the negative active material layer has heat release A1 satisfying 2 J/g≤A1≤50 J/g;
a second exothermic peak from 220° C. to 260° C., in which the negative active material layer has heat release A2 satisfying 20 J/g≤A2≤100 J/g; and
a third exothermic peak from 260° C. to 310° C., in which the negative active material layer has heat release A3 satisfying 200 J/g≤A3≤600 J/g.

20. The electricity-consumption device of claim 19, wherein a particle diameter Dv50 of the negative active material satisfies 10 μm≤Dv50≤17 μm, wherein the Dv50 refers to a particle diameter when a cumulative volume fraction reaches 50% in measuring a volume-based distribution using a laser scattering method.
